(19) United States
(12) Patent Application Publication
(10) Pub. No.: US 2011/0052408 A1
(43) Pub. Date: Mar. 3, 2011

(54) SWEPT BLADES UTILIZING ASYMMETRIC DOUBLE BIASED FABRICS

(76) Inventor: Michael D. Zuteck, Clear Lake Shores, TX (US)

(21) Appl. No.: 12/547,402

(22) Filed: Aug. 25, 2009

(51) Int. Cl. F03D 11/00; B29C 45/14

(52) U.S. Cl. 416/241 R; 264/257

(57) ABSTRACT

A swept turbine blade may include a blade shell formed from a variety of fabric types, including an asymmetric double-biased fabric. This asymmetrical double-biased fabric may include fibers with a crossing angle of less than 80°. The fabric may alternately include fibers of a first type or fraction extending in one direction and fibers of a different type or fraction extending in a second direction. This fabric may be curved in the direction of the blade sweep when used in the swept turbine blade.

### BACKGROUND

1. Field of the Invention

The invention is directed generally to wind turbine blade design.

2. Description of the Related Art

Wind turbine blades typically comprise a blade shell formed from one or more skins, which may themselves be formed from several layers of fabric. Swept blades, particularly swept blades that utilize sweep-twist coupling to shed loads, may benefit from fabrics and uses of fabrics which differ from those traditionally used in the construction of straight blades. In particular, the fabric of a straight blade generally does not need to be significantly curved within the plane of the fabric to accommodate the shape of the blade, while such curvature may be necessary to accommodate certain fabric layouts used in a swept blade. This curvature places additional constraints on the type of fabrics which can be used, but the geometry of swept blades can also be leveraged to provide or amplify a desired response under load though the use of specific fabrics and orientations.

### SUMMARY OF CERTAIN EMBODIMENTS

In one aspect, a swept wind turbine blade is provided, including a blade shell, the blade shell including a double biased fabric having a first plurality of fibers extending in a first direction and a second plurality of fibers extending in a second direction, the first plurality of fibers crossing the second plurality of fibers at a crossing angle, where the crossing angle is less than 80°.

In another aspect, a swept wind turbine blade is provided, including a swept blade shell, where the blade shell includes a double-biased fabric layer having a first plurality of fibers extending from the trailing edge towards the leading edge in an outboard direction, and a second plurality of fibers extending from the leading edge towards the trailing edge in an outboard direction, where a physical property of the first plurality of fibers is different from the same physical property of the second plurality of fibers.

In another aspect, a method of fabricating a swept turbine blade is provided, the method including providing at least one swept shell mold, the mold defining at least a root section, a location of maximum chord, a first edge which is at least partially convex, and a second edge which is at least partially concave in a region outboard of the location of maximum chord, and positioning at least one asymmetrical double-biased fabric within the blade mold, the fabric including a first plurality of fibers extending from the second edge towards the first edge in a direction away from the root section and a second plurality of fibers extending from the first edge towards the second edge in a direction away from the root section, where the double-biased fabric is curved along a curved fabric axis.

In another embodiment, a method of fabricating a swept turbine blade is provided, the method including providing at least one swept shell mold, the mold defining at least a root section, a location of maximum chord, a first edge which is at least partially convex, and a second edge which is at least partially concave in a region outboard of the location of maximum chord, and positioning at least one double-biased fabric within the blade mold, the fabric including a first plurality of fibers extending from the second edge towards the first edge in a direction away from the root section and a second plurality of fibers extending from the first edge towards the second edge in a direction away from the root section, where the double-biased fabric is curved along a curved fabric axis, and where the first plurality of fibers crosses the second plurality of fibers at a crossing angle less than 80°.

### BRIEF DESCRIPTION OF THE DRAWINGS

FIG. 1 is a perspective view of a wind turbine comprising three swept wind turbine blades.

FIG. 2 is a top plan view of a swept wind turbine blade.

FIG. 3 is a cross-sectional view of the swept wind turbine blade of FIG. 2 taken along the line 3-3 of FIG. 2.

FIG. 4 is a top plan view of a fabric section which schematically illustrates a double biased fabric having fibers which make less than a 45° angle with a fabric axis.

FIG. 5 is a top plan view of another fabric section which schematically illustrates an asymmetrically oriented double-biased fabric

### DETAILED DESCRIPTION OF CERTAIN EMBODIMENTS

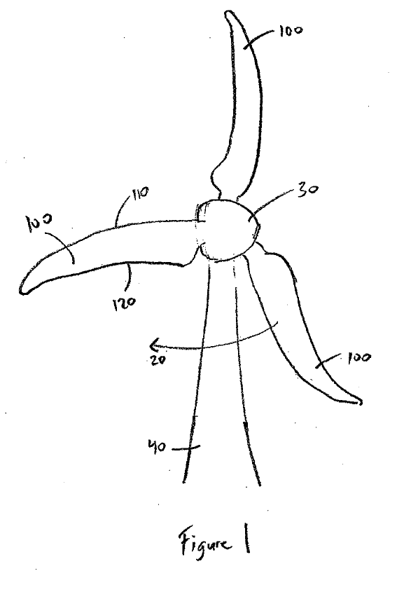

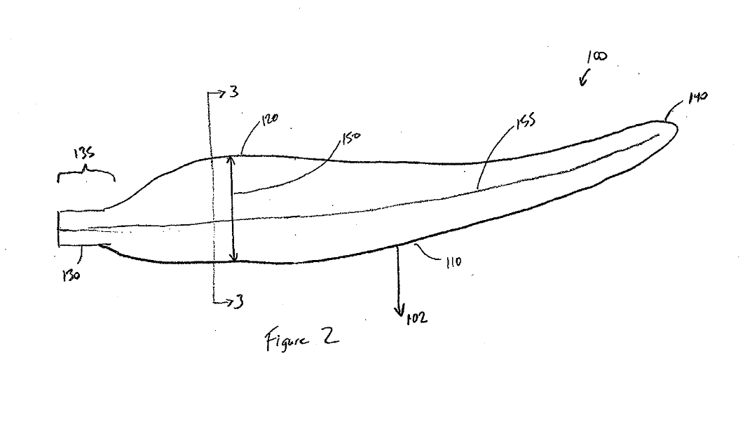

FIG. 1 depicts an exemplary wind turbine 10 comprising three wind turbine blades 100 extending radially from a wind turbine hub 30 mounted on a tower 40. The wind turbine rotates in a direction 20, such that a leading edge 110 of a blade 100 and a trailing edge 120 are oriented as shown in FIG. 1. FIG. 2 is a top plan view of an exemplary swept wind turbine blade 100 of FIG. 1. The chord length of the blade is measured from the leading edge 110 to the trailing edge 120 within a twisting plane whose outer part lies near the plane of rotation of the blade 100 in its full power setting. This chord length initially increases as the distance from a blade root 130 increases, until reaching a maximum chord length 150, and then decreases towards a tip 140 of the blade.

It can be seen in FIG. 2 that the tip 140 of the blade is swept backwards, in a direction away from the leading edge 110. The particular shape of the blade may be defined with respect to a layout axis 155, which can be alternatively referred to as the stacking axis. In certain embodiments, the layout axis is defined as a line connecting the centers of area or other chosen reference points (such as a percentage of chord from the leading edge) within transverse sections of the airfoil.

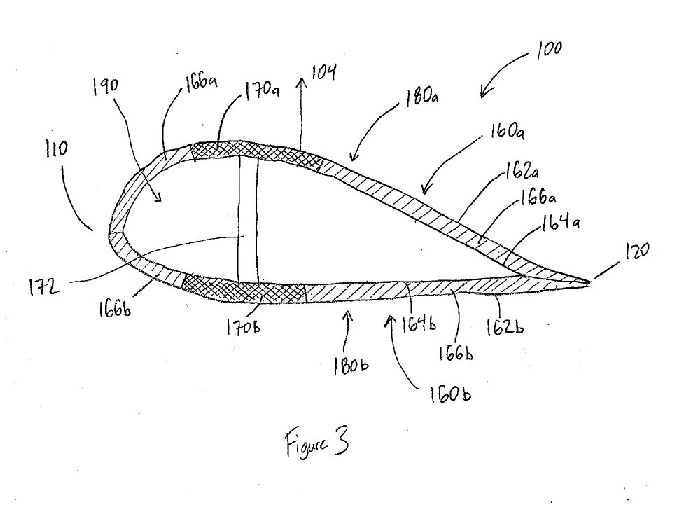

The outer surfaces of typical modern wind turbine blades, also referred to herein as shells, are comprised of an inner skin, an outer skin, and a stabilizing core, as will be described in greater detail with respect to FIG. 3 below. Typically, these skins run from the leading edge 110, or nose of the blade to the trailing edge 120, or tail of the blade, so that the need to cut or join fabrics at an intermediate point is minimized or avoided, simplifying the construction of the blade. For blades with very large maximum chord lengths, fabric of sufficient width to run from the nose to the tail may be prohibitively difficult and/or expensive to obtain. Thus, production of the fabric covering for the blade length generally requires the joining of fabric sections to form a skin which extends from the nose to the tail of the blade. Of course, it is desirable to minimize the number of such joints. These skins thus typically provide constant mechanical properties, such as the shear modulus of the skin, along their lengths.

In certain embodiments, these skins may comprise multiple types of fabric, so as to provide a resultant structure equipped to handle the loads to which a wind turbine blade will be exposed while in use. Two commonly used types of fabrics are unidirectional fabrics, in which the fibers are oriented in a single direction, and double-biased fabrics, in which the fibers are oriented at an angle to one another. By utilizing a combination of unidirectional and double-biased fabrics, a structure can be provided in which the unidirectional fibers bear certain loads, primarily resisting bending of the blade, and the double-biased fabric bears other loads, providing resistance against both bending and twisting.

FIG. 3 is an illustration of an exemplary cross-section of the blade 100 of FIG. 2, taken along the line 3-3 of FIG. 2. The blade 100 comprises an upper shell 160a located on a first or upper surface 180a of blade 100 and a lower shell 160b located on a second or lower surface 180b of blade 100, and an interior stiffening structure comprising spar caps 170a and 170b and shear web 172, each of which are located in or between the upper and lower shells. As noted above, the shells 160a and 160b are composite structures. In particular, shell 160a comprises an outer skin 162a, an inner skin 164a, and a core 166a located therebetween. The outer and inner skins 162a and 164a may comprise fiberglass or another suitable material in an appropriate thickness. The particular thickness and properties of the outer and inner skins 162a and 164a may vary significantly in various embodiments.

The interior stiffening structure, referred to herein as a spar or main spar, comprises the pair of spar caps 170a and 170b extending adjacent the inner skins 164a and 164b of the upper and lower shells, and extending along part of the chord length of the shells, and the shear web 172 extending between the spar caps 170a and 170b. In the illustrated embodiment, the spar caps 170a and 170b are disposed between the inner skin 164a and the outer skin 164b of the adjacent shell sections and of the stiffening cores 166a and 166b. In such an embodiment, the skins may be formed over the spar caps and the core sections to form shells 160a and 160b, and the shells may then be assembled to form a blade. In an alternate embodiment, however, the shells may be formed without the spar caps, such that the inner skin is brought into contact with the outer skin, leaving a gap between the core sections where a spar cap can later be placed.

In the illustrated embodiment, a single shear web 172 extends between the spar caps 170a and 170b to form essentially an I-beam structure. In certain embodiments, some or all of the spar caps 170a and 170b and shear web 172 comprise a high performance material such as carbon fiber, although these structural members may comprise multiple materials at different locations within the structural members.

Referring again to FIG. 1, when installed on a turbine, the turbine blade 100 may be subjected to a variety of loads. Power producing torque, drag forces and gravitational forces may act predominantly within the plane of rotation, subjecting the turbine blade to in-plane bending, also referred to as edgewise bending. This edgewise bending will result in deformation, typically in the direction of rotation, such as in the direction illustrated as 102 in FIG. 2, thereby causing the blade to bend, or sweep, in a forward direction. Power producing torque generally dominates over air drag, and the net effect of gravity will average to zero when the blade is rotating. Resistance to edgewise bending is generally provided by the shell structure of the blade.

The turbine blade may also be subjected to loads acting out of the plane of rotation, such as the force of wind acting on the facing surface of the blade, as well as the lift generated by air flow past the blade. These forces will result in flapwise bending of the turbine blade out of the plane of rotation, such as in direction 104 of FIG. 3. Resistance to flapwise bending is generally provided by the beam structure formed by the shear web(s) 172 and spar caps 170a,b. although some shear is also carried by the nose and trailing edge paths.

When a turbine blade 100 is swept in an aft direction 102, away from the leading edge 110, a bending moment is created which induces twist in the blade. The degree to which the induced twist will affect the overall twist of the blade is dependent on both the resistance to applied torsional forces and the location at which a given amount of twist is induced.

As noted above, the skins are formed from multiple layers of fabric, which can be placed one upon another in a mold to form a stack of fabric of the desired thickness in the desired blade shell shape. Stiffness of the structure is provided by resin which can be applied to the fabric prior to or during the molding process. Fabric pieces which run from the root of the blade to the tip of the blade, or a substantial section thereof, will provide optimal performance as transition regions between fabric pieces can be avoided over the length of the blade. When forming a swept blade, the curvature of the blade requires that portions of the fabric near the leading edge 110 of the blade be stretched to accommodate the blade shape, and the portions of the fabric near the trailing edge 120 of the blade will be compressed.

It will be understood that the junctions between the shell sections of the blade may not be located directly at the leading and trailing edges of the blade. Thus, the leading and trailing edges of a mold for a blade shell may not correspond directly to the leading and trailing edges of the eventual blade. Nevertheless, a blade mold for a swept turbine blade will generally have a first edge which is at least partially convex which will form the edge of the blade shell located near the leading edge. Similarly, the blade mold will generally have a second edge which is at least partially concave in a region outboard of the location of maximum chord which will form the edge of the blade shell located near the trailing edge. Other portions of the trailing side of the blade mold may be convex, particularly around the region of maximum chord. The location of maximum chord for a shell section may have a length which is less than the maximum chord length of the finished blade, because at least one of the blade shells may not extend all the way to the leading or trailing edge of the finished blade. In some embodiments, the leading joint between an upper and lower blade shell may be located at the stagnation point, rather than directly at the leading edge. The blade mold will also have other sections, such as a root region to form the base of the blade shell, a location of maximum chord as noted above, a transition section between the root and the location of maximum chord, and an outboard section at greater radius than maximum chord.

As also noted above, biased fabrics such as double-bias fabrics, in which the fibers of the fabric are oriented in two distinct directions at a 90° angle to one another, can be used in the fabrication of blade skins. These fabrics are widely available in a 45/45 orientation, wherein each of the fibers are oriented at a ±45° angle to the direction of the fabric. 45/45 fabrics are used as a component of many blade designs, as they provide stiffness both in an edgewise and a spanwise direction, good shear resistance, and good tolerance of maximum strain before initiating resin fracture.

As noted above, however, blade designs which make use of sweep-twist coupling to reduce loads may benefit from an increased twist response. As the twist response is dependent on both the local torsional moment and the resistance to torsional rotation, a reduction in the torsional stiffness of the blade will result in an increased twist response for a given torsional moment. For double-biased fabric in a swept blade, the fabric may be placed within a blade mold such that a fabric axis of the fabric is curved generally along a curved axis such as the layout axis of the blade, such that the angle of the fibers to the fabric direction will be generally similar to the angle the same fibers make with the curved axis. The curved axis along which the fabric is oriented will be referred to herein as the layout axis, although it will be understood that the fabric may be curved along an axis which is different from the layout axis. In other embodiments, the fabric may be curved along an axis which runs substantially along the physical center of the blade. In particular embodiments, the fabric may be curved along the physical center of the blade in sections outboard of maximum chord.

A decrease in the angle made with the layout axis will increase the spanwise stiffness of the blade, while decreasing the chordwise stiffness of the blade, as the fibers will generally be oriented in a direction more parallel to the layout axis. Similarly, an increase in the angle made with the layout axis will increase the chordwise stiffness of the fabric, as the fibers will be oriented in a direction more perpendicular to the layout axis.

If the angle the fibers make with respect to the layout axis is reduced, the shear stiffness of the fabric is reduced, while the resistance to bending of the blade will be increased. In traditional straight turbine blades, this reduction in shear stiffness may be unimportant or undesirable. For swept blades, some reduction in shear stiffness can instead be beneficial, as some reduction in shear stiffness will yield an increased twist response due to the reduction in torsional stiffness of the blade, so long as the flutter instability boundary is not excessively lowered.

In certain embodiments, custom double-biased fabric may be used in which the fibers are oriented at an angle of less than 45° to the fabric direction. When the fabric direction is aligned with the layout axis, the decreased fiber angle will reduce the shear stiffness to increase the twist response, while maintaining or increasing the resistance to bending of the blade.

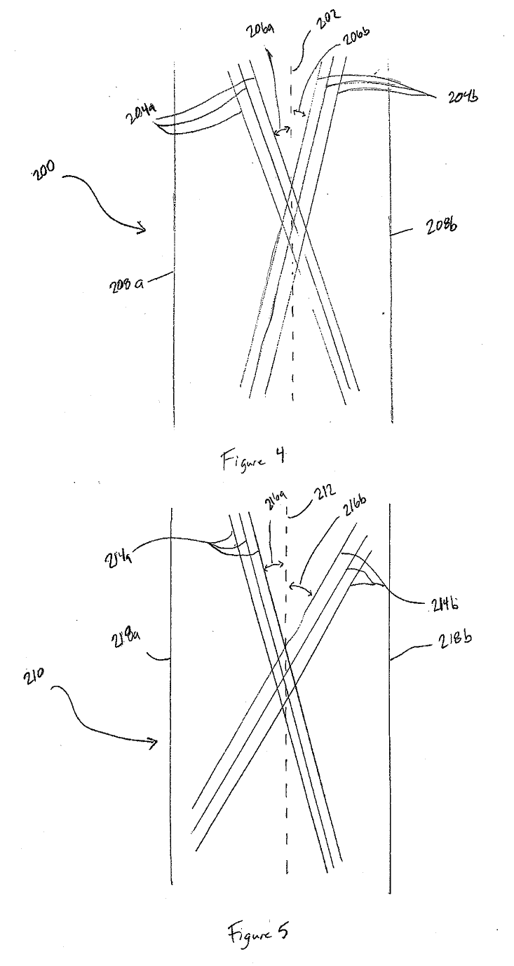

FIG. 4 schematically illustrates such an embodiment of a fabric 200 which comprises fibers 204a and 204b which extend at angles 206a and 206b, respectively, to the direction 202 of the fabric. In particular embodiments, the angles 206a and 206b at which the fibers 204a and 204b extend relative to the fabric axis 202 are less than 40° (corresponding to an angle between fibers of 80° along the fabric axis), and greater than 10° (corresponding to an angle between fibers of 20° along the fabric axis). In further embodiments, these angles 206a and 206b may be greater than 15°. The particular angle utilized by a given fabric may vary based on both the amount of fabric to be used in the blade skin and the ratio of the custom double-biased fabric to other fabric (such as unidirectional fabric). If a decrease in shear stiffness is desired, this can be achieved both by reducing the angle of the fibers, or by decreasing the proportion of double-biased fabric relative to unidirectional fabric in the blade skin. Thus, a custom fabric within the angle range provided above may be used for a wide variety of blade designs by varying the amount of fabric used, rather than optimizing the fiber angle of each fabric for a given blade design. Significant cost savings may thus be realized, as the custom fabric may be provided in greater amounts.

In still further embodiments, one or more of the properties of the double-biased fabric may be asymmetrical, and this asymmetry may be utilized in order to increase the twist response of the blade under load. In one embodiment, the fibers may make different angles with respect to the direction of the fabric. FIG. 5 illustrates such an asymmetrical double-biased fabric 210, in which fibers 214a are oriented at an angle 216a to the fabric axis 212, and fibers 214b are oriented at an angle 216b to the fabric axis 212. The fabric angles discussed herein are measured between the fabric axis and the fabric fibers extending in an outward direction of the blade. Because of the asymmetrical properties of this fabric 210, the orientation of the fabric will affect the properties of a turbine blade incorporating this fabric. In particular, if the fabric is oriented such that the fabric near edge 218a is located near the leading edge of a wind turbine blade, the properties will be different than if the fabric near edge 218a were located near the trailing edge of the wind turbine blade.

When used in conjunction with a swept turbine blade such as the blade 100 of FIG. 2, the twist response of the blade can be enhanced by laying the fabric such that the edge 218a is in the direction of the trailing edge 120, and the edge 218b is in the direction of the leading edge 110. The fibers 214b will be oriented as a positive angle relative to an axis of the blade 100, such as the layout axis 155, thereby increasing the twist response. The fibers 214a oriented at an angle behind the blade axis will inhibit the twist of the blade tip, but by minimizing the angle that the fibers 214a make with the blade axis, the ability of these fibers to inhibit twisting will be decreased, and the fibers will provide increased resistance against bending, rather than resistance against twisting.

While a similar effect could be approximated by laying double-biased fabric at an angle to the blade axis, the length of the turbine blade is typically very large relative to the width of fabric swaths, and forming an entire blade shell would require multiple diagonal strips of fabric, each of which would need to be bonded to adjacent strips. These bonds could weaken the skins, and would increase the thickness and weight of the skins, making such an embodiment undesirable. By providing asymmetric fabric such as fabric 610 of FIG. 5, the benefits of the asymmetrical bias can be realized while using only a minimal amount of fabric pieces to extend the width of the blade skin. This may be as low as a single fabric piece for blades in which the maximum chord width does not exceed the width of the fabric pieces.

Other methods of forming fabrics having asymmetrical properties may be provided. In one embodiment, the fabric 200 of FIG. 4, in which the fibers 204a and 204b are oriented at equal angles to the fabric axis, may be modified such that the fibers 204a and 204b are formed from different materials. In a particular embodiment, the fibers 204b may be made of a stiffer material than the material of fibers 204a, and the fabric may be oriented in the blade mold such that the side 208b towards which the stiffer fibers 204 are angled is oriented towards the leading edge of a swept blade. The increased stiffness along fibers angled toward the leading edge of the blade, along with the decreased stiffness along fibers angled towards the trailing edge of the blade, will increase the twist response of the blade.

Similarly, the ratio of fibers 204a to fibers 204b may be adjusted to provide asymmetric fabric strength. In a particular embodiment, the density of the fibers 204b may be increased relative to the density of the fibers 204a, and the fabric may be oriented within the blade skin such that the side 208 of the fabric is oriented towards the leading edge of a swept blade. The increased number or thickness of the fibers 204b may increase the twist response by increasing the stiffness of the fibers angled forward of the blade axis while decreasing the stiffness of the fibers angled aft of the blade axis.

Any combination of the above techniques for utilizing modified double-bias fabrics to increase the twist response of swept blades may be utilized. For example, the density or composition of the fibers oriented in a first direction may also be modified relative to the fibers oriented in a second direction when the fibers are oriented at different angles to the blade axis, such as in the fabric 210 of FIG. 5. Other combinations of the above techniques are contemplated and within the scope of the present invention.

Various other combinations of the above embodiments and methods discussed above are contemplated. It will be understood that the above fabrics and fabric configurations may be used either alone or in conjunction with other fabrics and configurations discussed above and known to persons of ordinary skill in the art. For example, these fabrics and techniques may be used in the fabrication of only one of the skins which forms the blade shell. It is also to be recognized that, depending on the embodiment, the acts or events of any methods described herein can be performed in other sequences, may be added, merged, or left out altogether (e.g., not all acts or events are necessary for the practice of the methods), unless the text specifically and clearly states otherwise.

While the above detailed description has shown, described, and pointed out novel features as applied to various embodiments, various omissions, substitutions, and changes in the form and details of the device of process illustrated may be made. Some forms that do not provide all of the features and benefits set forth herein may be made, and some features may be used or practiced separately from others.

What is claimed is:

1. A swept wind turbine blade, comprising:
a blade shell, the blade shell comprising a double biased fabric having a first plurality of fibers extending in a first direction and a second plurality of fibers extending in a second direction, the first plurality of fibers crossing the second plurality of fibers at a crossing angle;
wherein said crossing angle is less than 80°.

2. The blade of claim 1, wherein the crossing angle is greater than 20°.

3. The blade of claim 1, wherein the crossing angle is less than 60°.

4. The blade of claim 1, wherein the first plurality of fibers extend from the trailing edge of the blade towards the leading edge of the blade in an outboard direction, and wherein the second plurality of fibers extend from the leading edge of the blade towards the trailing edge of the blade in the outboard direction.

5. The blade of claim 4, wherein the first plurality of fibers comprise a first material, and wherein the second plurality of fibers comprise a second material, wherein the first material is different from the second material.

6. The blade of claim 5, wherein the first plurality of fibers are stiffer than the second plurality of fibers.

7. The blade of claim 4, wherein the first plurality of fibers are oriented at a first angle to the direction of the fabric, and wherein the second plurality of fibers are oriented at a second angle to the direction of the fabric.

8. The blade of claim 7, wherein the first angle is greater than the second angle.

9. The blade of claim 4, wherein the fabric comprises a greater percentage by weight of the first plurality of fibers than the second plurality of fibers.

10. The blade of claim 1, wherein the double-biased fabric is curved to follow the sweep of the blade.

11. A swept wind turbine blade, comprising:
a swept blade shell, wherein the blade shell comprises a double-biased fabric layer having a first plurality of fibers extending from the trailing edge towards the leading edge in an outboard direction, and a second plurality of fibers extending from the leading edge towards the trailing edge in an outboard direction;
wherein a physical property of the first plurality of fibers is different from the same physical property of the second plurality of fibers.

12. The blade of claim 11, wherein the first plurality of fibers is stiffer than the second plurality of fibers.

13. The blade of claim 11, wherein the blade comprises a layout axis, and wherein a first angle between the first plurality of fibers and the layout axis in an outboard direction is greater than a second angle between the second plurality of fibers and the layout axis in an outboard direction.

14. The blade of claim 11, wherein the first plurality of fibers comprises a first material and the second plurality of fibers contains a second material.

15. The blade of claim 11, wherein the percentage by weight of the first plurality of fibers is greater than the percentage by weight of the second plurality of fibers.

16. A method of fabricating a swept turbine blade, the method comprising:
providing at least one swept shell mold, the mold defining at least a root section, a location of maximum chord, a first edge which is at least partially convex, and a second edge which is at least partially concave in a region outboard of the location of maximum chord; and
positioning at least one asymmetrical double-biased fabric within the blade mold, the fabric comprising a first plurality of fibers extending from the second edge towards the first edge in a direction away from the root section and a second plurality of fibers extending from the first edge towards the second edge in a direction away from the root section, wherein the double-biased fabric is curved along a curved fabric axis.

17. The method of claim 16, wherein a physical property of the first plurality of fibers is different from the same physical property of the second plurality of fibers.

18. The method of claim 16, wherein the first plurality of fibers crosses the second plurality of fibers at a crossing angle less than 80°.

19. The method of claim 18, wherein the crossing angle is greater than 20°.

20. The method of claim 18, wherein the crossing angle is less than 60°.

21. The method of claim 16, wherein the first plurality of fibers comprise a first material, and wherein the second plurality of fibers comprise a second material, wherein the first material is different from the second material.

22. The method of claim 16, wherein the first plurality of fibers is stiffer than the second plurality of fibers.

23. The method of claim 16, wherein the fabric comprises a fabric axis, the first plurality of fibers being oriented at a first angle to the fabric axis, and the second plurality of fibers being oriented at a second angle to the fabric axis.

24. The blade of claim 23, wherein the first angle is greater than the second angle.

25. The method of claim 16, wherein the curved axis comprises a layout axis of the blade.

26. The method of claim 16, wherein the fabric comprises a greater percentage by weight of the first plurality of fibers than the second plurality of fibers.

27. A method of fabricating a swept turbine blade, the method comprising:
providing at least one swept shell mold, the mold defining at least a root section, a location of maximum chord, a first edge which is at least partially convex, and a second edge which is at least partially concave in a region outboard of the location of maximum chord; and
positioning at least one double-biased fabric within the blade mold, the fabric comprising a first plurality of fibers extending from the second edge towards the first edge in a direction away from the root section and a second plurality of fibers extending from the first edge towards the second edge in a direction away from the root section, wherein the double-biased fabric is curved along a curved fabric axis, and wherein the first plurality of fibers crosses the second plurality of fibers at a crossing angle less than 80°.

28. The method of claim 27, wherein the crossing angle is greater than 20°.

29. The method of claim 27, wherein the crossing angle is less than 60°.

30. The method of claim 27, wherein a physical property of the first plurality of fibers is different from the same physical property of the second plurality of fibers.
